(19) United States
(12) Patent Application Publication
(10) Pub. No.: US 2009/0101080 A1
(43) Pub. Date: Apr. 23, 2009

(54) AVIAN AVERTING SYSTEM AND ASSOCIATED METHODS

(76) Inventor: Richard M. SELZER, Rockwall, TX (US)

Correspondence Address: SMITH IP SERVICES, P.C., P.O. Box 997, Rockwall, TX, 75087, US

(21) Appl. No.: 11/875,689

(22) Filed: Oct. 19, 2007

(51) Int. Cl. A01K 29/00

(52) U.S. Cl. 119/713

(57) ABSTRACT

An avian averting system for buildings including multiple structures includes multiple base strips, each of the base strips having electrical conductors attached thereto; an electrical power supply; and releasable fasteners for releasably fastening the base strips to the structures. A method is provided which includes the steps of: releasably attaching a bird aversion system to a first one of the structures; then maintaining the bird aversion system attached until the birds are conditioned to avoid the structure; then removing the bird aversion system from the first structure; then releasably attaching the bird aversion system to a second one of the structures; and then maintaining the bird aversion system attached to the second structure until the birds are conditioned to avoid the second structure.

### BACKGROUND

The present invention relates generally to building protection and, in an embodiment described herein, more particularly provides an avian averting system and associated methods.

Various techniques have been used in the past for removing birds from buildings, signs, trees, etc. These techniques include installing spikes, wires, nets or electrical conductors on surfaces of structures. However, it is uneconomical to install certain of these devices on buildings which may have many hundreds or thousands of structures to protect.

Therefore, it may be seen that improvements are needed in the art of avian averting systems and associated methods.

### SUMMARY

In the present specification, a system and method are provided which solve at least one problem in the art. One example is described below in which the system is designed to be conveniently portable from one structure to another. Another example is described below in which the system is relocated after birds are conditioned to avoid a particular structure.

In one aspect, an avian averting system for buildings including multiple structures is provided. The system includes multiple base strips, each of the base strips having electrical conductors attached thereto; a power supply for supplying electrical power to the electrical conductors; and releasable fasteners for releasably fastening the base strips to the structures.

In another aspect, a method of removing birds from multiple structures on a building is provided which includes the steps of: releasably attaching a bird aversion system to a first one of the structures; then maintaining the bird aversion system attached to the first one of the structures until the birds are conditioned to avoid the first one of the structures; then removing the bird aversion system from the first one of the structures; then releasably attaching the bird aversion system to a second one of the structures; and then maintaining the bird aversion system attached to the second one of the structures until the birds are conditioned to avoid the second one of the structures.

These and other features, advantages, benefits and objects will become apparent to one of ordinary skill in the art upon careful consideration of the detailed description of representative embodiments of the invention hereinbelow and the accompanying drawings, in which similar elements are indicated in the various figures using the same reference numbers.

### BRIEF DESCRIPTION OF THE DRAWINGS

FIG. 1 is an isometric view of a building utilizing an avian averting system and associated method embodying principles of the present invention;

FIG. 2 is an enlarged scale plan view of the system releasably attached to a structure of the building;

FIG. 3 is a plan view of an alternate configuration of the system; and

FIG. 4 is an enlarged scale elevational view of a releasable attachment of the system to the structure.

### DETAILED DESCRIPTION

It is to be understood that the various embodiments of the present invention described herein may be utilized in various orientations, such as inclined, inverted, horizontal, vertical, etc., and in various configurations, without departing from the principles of the present invention. The embodiments are described merely as examples of useful applications of the principles of the invention, which is not limited to any specific details of these embodiments.

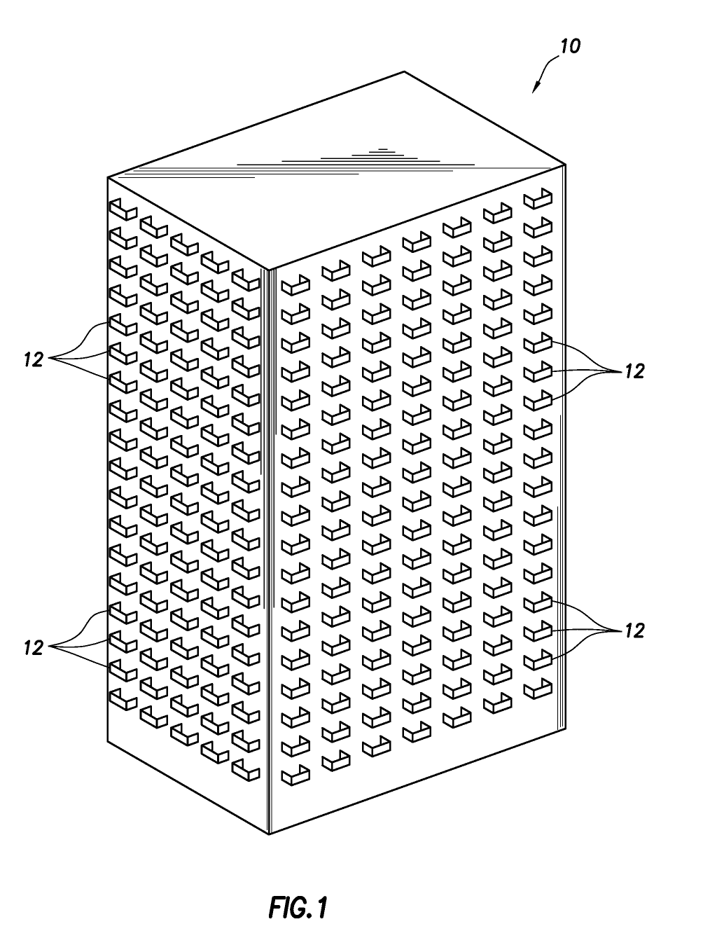

Representatively illustrated in FIG. 1 is a building 10 which may include an avian averting system embodying principles of the present invention. The building 10 has many structures 12 thereon which attract birds. The structures 12 are depicted in FIG. 1 as being balconies or terraces, but other types of structures could exist, such as ledges, ornamental structures, signs, fixtures, etc.

If the building 10 is sufficiently large, it may include hundreds or even thousands of such structures 12. It will be appreciated, then, that it would be very costly to equip each of the structures 12 with a permanently affixed bird deterrent system. And if the building 10 were to be equipped with such a large number of bird deterrent systems, it would likely render the building unsightly and detract from its perceived value.

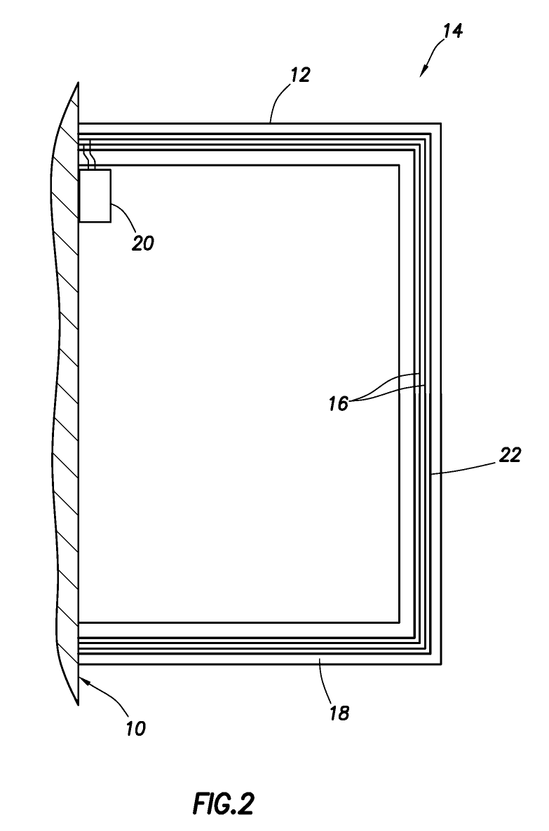

Instead, the building 10 is provided with a portable avian averting system 14 which embodies principles of the present invention. A first example of the system 14 is representatively illustrated in FIG. 2 from a top plan view thereof.

As depicted in FIG. 2, the system 14 includes electrical conductors 16 releasably attached to an upper surface 18 of one of the structures 12. The conductors 16 are preferably attached about an outer perimeter of the structure 12, i.e., at locations where birds would be expected to land. If the structure 12 is differently shaped, then locations other than an outer perimeter may be selected for attachment of the electrical conductors 16.

An electrical power supply 20 is used to provide electrical potential to the conductors 16. Preferably, the electrical potential is low enough that the birds are not physically harmed when they contact the conductors 16, but the electrical potential is high enough that the birds find it unpleasant and will not remain in contact with the conductors. Sources of electricity for the power supply 20 may include a battery, utility power, solar power, etc.

Various means may be used for supporting the conductors 16 on the surface 18. A support 22 is depicted in FIG. 2 in the form of a relatively flat base strip which conforms to the shape of the structure 12. Other types of supports may be used, such as individual posts or towers, etc., if desired.

The conductors 16, power supply 20 and support 22 are preferably not permanently attached to the structure 12. Instead, the system 14 remains attached to the structure 12 as long as is needed to condition the birds to avoid the structure. Then, the system 14 can be easily and conveniently removed from the structure 12 and relocated to another structure in need of protection from birds.

The bird conditioning mentioned above relates to behavior modification in which the birds are influenced to avoid the structure 12. This type of behavior modification was investigated and described by Ivan Pavlov.

As part of the relocation procedure, the system 14 is again releasably attached to one of the structures 12 on the building 10, and remains attached as long as is needed to condition the birds to avoid the structure. After the birds have been properly conditioned, the system 14 can be relocated to yet another one of the structures 12, and the system can eventually be relocated back to the first structure on which it was installed, in the event that the birds return to that structure.

It may now be appreciated that the system 14 and associated method enable only one or a few of the systems to be used to condition the birds to avoid all of the structures 12 on the building 10. It is, therefore, not necessary to install a separate avian averting system 14 on each of the structures 12. Instead, after the birds are conditioned to avoid a particular structure 12, the system 14 is available for use on another structure, since it is not needed on any structures which the birds are already conditioned to avoid.

Referring additionally now to FIG. 3, an alternative configuration of the system 14 is representatively illustrated. In this configuration, multiple supports 22 are used for the conductors 16. The supports 22 are in the form of individual base strips provided as separate elements.

Jumper wires 24 are used to connect the conductors 16 between the separate supports 22. The power supply 20 is also connected to the conductors 16 with jumper wires 24. Quick connect connectors 26 may be used to facilitate the ease and convenience of connecting the wires 24 to the conductors 16.

Alternatively, prefabricated corner connectors could be used to structurally connect the separate supports 22, and to electrically connect the conductors 16 at the corners, without requiring use of the jumper wires 24 or quick connect connectors 26.

It will be appreciated that the system 14 of FIG. 3 is more modular in design and can be easily adapted to the shapes of different structures 12. In addition, the modular design provides for ease and convenience in transporting the system 14 between different locations on the building 10.

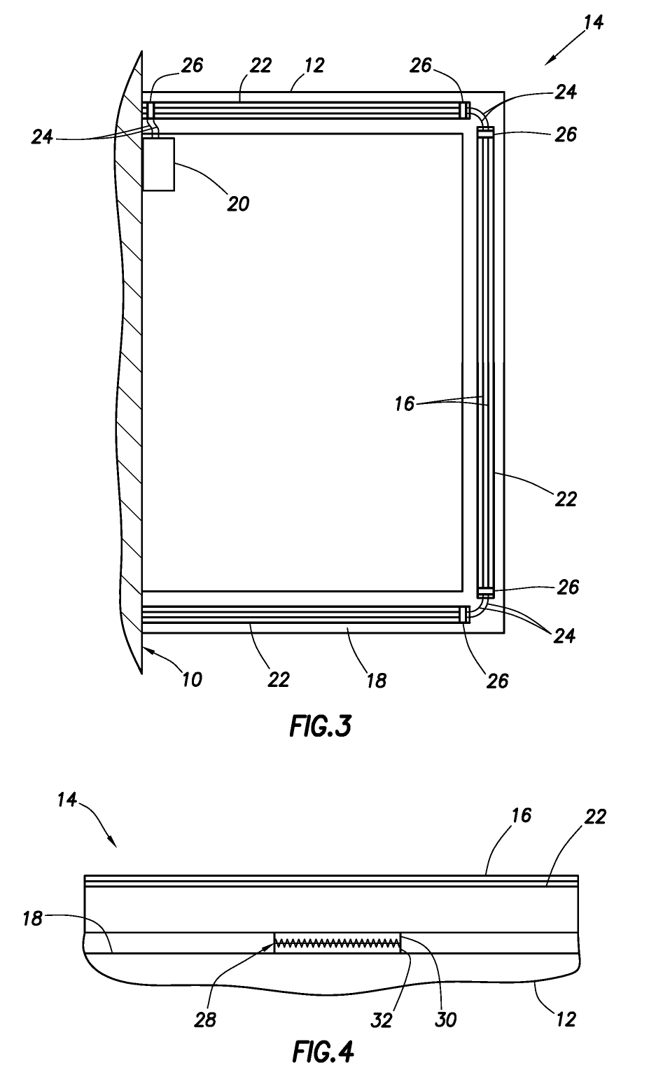

Referring additionally now to FIG. 4, a method of releasably attaching the system 14 to the structure 12 is representatively illustrated. This releasable attachment helps to make the system 14 portable, so that it can be utilized on multiple structures, and so that it can be again attached to a structure on which it was previously attached.

As depicted in FIG. 4, the system 14 includes releasable fasteners 28 for releasably attaching the support 22 to the surface 18. Preferably, the fasteners 28 are spaced apart along the length of the support 22 at regular intervals.

The fastener 28 illustrated in FIG. 4 is of the meshing reclosable type, with one side 30 adhesively attached to the support 22, and the other side 32 adhesively attached to the surface 18. The fastener 28 could be, for example, DUAL LOCK™ available from 3M Corporation, or hook-and-loop fasteners, etc. Other types of releasable fasteners may be used, if desired.

It may now be fully appreciated that the above description provides significant advancements in the art of removing undesirable birds from multiple structures of a building. In particular, a method of removing birds from multiple structures 12 on a building 10 is provided which includes the steps of: releasably attaching a bird aversion system 14 to a first one of the structures 12; then maintaining the bird aversion system attached to the first one of the structures until the birds are conditioned to avoid the first one of the structures; then removing the bird aversion system 14 from the first one of the structures 12; then releasably attaching the bird aversion system to a second one of the structures; and then maintaining the bird aversion system 14 attached to the second one of the structures 12 until the birds are conditioned to avoid the second one of the structures.

The method may also include the steps of: after the step of then maintaining the bird aversion system 14 attached to the second one of the structures 12 until the birds are conditioned to avoid the second one of the structures, then removing the bird aversion system from the second one of the structures; then releasably attaching the bird aversion system 14 to a third one of the structures 12; and then maintaining the bird aversion system 14 attached to the third one of the structures 12 until the birds are conditioned to avoid the third one of the structures.

The method may also include the steps of: removing the bird aversion system 14 from the second one of the structures 12; then releasably attaching the bird aversion system 14 to the first one of the structures 12; and then maintaining the bird aversion system 14 attached to the first one of the structures 12 until the birds are again conditioned to avoid the first one of the structures.

The method may include repeating, for each of the structures 12, the steps of releasably attaching the bird aversion system 14 to the structure, then maintaining the bird aversion system attached to the structure until the birds are conditioned to avoid the structure, and then removing the bird aversion system 14 from the structure 12.

In the method, the bird aversion system 14 may include electrical conductors 16 for applying an electrical deterrent to the birds. The bird aversion system 14 may also include a power supply 20 for supplying electrical power to the electrical conductors 16. The bird aversion system 14 may also include releasable fasteners 28 which releasably fasten the electrical conductors 16 to the structures 12.

Also provided by the above description is a bird averting system 14 for buildings including multiple structures 12. The system 14 includes multiple base strips (supports 22), each of the base strips having electrical conductors 16 attached thereto; a power supply 20 for supplying electrical power to the electrical conductors 16; and releasable fasteners 28 for releasably fastening the base strips to the structures 12. The releasable fasteners 28 may include meshing reclosable fasteners.

The base strips may be integrally formed as a single element which conforms to a shape of the structures 12. Alternatively, the base strips may be separately formed as separate elements. The system 14 may also include jumper wires 24 for connecting the electrical conductors 16 of the separate base strips.

Of course, a person skilled in the art would, upon a careful consideration of the above description of representative embodiments of the invention, readily appreciate that many modifications, additions, substitutions, deletions, and other changes may be made to these specific embodiments, and such changes are within the scope of the principles of the present invention. Accordingly, the foregoing detailed description is to be clearly understood as being given by way of illustration and example only, the spirit and scope of the present invention being limited solely by the appended claims and their equivalents.

What is claimed is:

1. A method of removing birds from multiple structures on a building, the method comprising the steps of:
releasably attaching a bird aversion system to a first one of the structures;
then maintaining the bird aversion system attached to the first one of the structures until the birds are conditioned to avoid the first one of the structures;
then removing the bird aversion system from the first one of the structures;
then releasably attaching the bird aversion system to a second one of the structures; and
then maintaining the bird aversion system attached to the second one of the structures until the birds are conditioned to avoid the second one of the structures.

2. The method of claim 1, further comprising the steps of:
after the step of then maintaining the bird aversion system attached to the second one of the structures until the birds are conditioned to avoid the second one of the structures, then removing the bird aversion system from the second one of the structures;
then releasably attaching the bird aversion system to a third one of the structures; and
then maintaining bird aversion system attached to the third one of the structures until the birds are conditioned to avoid the third one of the structures.

3. The method of claim 1, further comprising the steps of:
removing the bird aversion system from the second one of the structures;
then releasably attaching the bird aversion system to the first one of the structures; and
then maintaining the bird aversion system attached to the first one of the structures until the birds are again conditioned to avoid the first one of the structures.

4. The method of claim 1, further comprising repeating, for each of the structures, the steps of releasably attaching the bird aversion system to the structure, then maintaining the bird aversion system attached to the structure until the birds are conditioned to avoid the structure, and then removing the bird aversion system from the structure.

5. The method of claim 1, wherein the bird aversion system comprises electrical conductors for applying an electrical deterrent to the birds.

6. The method of claim 5, wherein the bird aversion system further comprises a power supply for supplying electrical power to the electrical conductors.

7. The method of claim 5, wherein the bird aversion system further comprises releasable fasteners which releasably fasten the electrical conductors to the structures.

8. A bird averting system for buildings including multiple structures, the system comprising:
multiple base strips, each of the base strips having electrical conductors attached thereto;
a power supply for supplying electrical power to the electrical conductors; and
releasable fasteners for releasably fastening the base strips to the structures.

9. The system of claim 8, wherein the base strips are integrally formed as a single element which conforms to a shape of the structures.

10. The system of claim 8, wherein the base strips are separately formed as separate elements.

11. The system of claim 10, further comprising jumper wires for connecting the electrical conductors of the separate base strips.

12. The system of claim 8, wherein the releasable fasteners comprise meshing reclosable fasteners.
